(19) United States
(12) Patent Application Publication
(10) Pub. No.: US 2026/0084657 A1
(43) Pub. Date: Mar. 26, 2026

(54) MULTIFUNCTIONAL CLEANING TOOL FOR VEHICLESP

(71) Applicant: Shenzhen Zhengling Electrical Appliances Co., Ltd., Shenzhen (CN)

(72) Inventor: QINBING ZHOU, Shenzhen (CN)

(21) Appl. No.: 19/083,704

(22) Filed: Mar. 19, 2025

Related U.S. Application Data
(63) Continuation-in-part of application No. 29/964,075, filed on Sep. 20, 2024.

(30) Foreign Application Priority Data
Mar. 14, 2025 (CN) 202520443331.6

(51) Int. Cl. B60S 3/00; A62B 3/00; B08B 1/12; B08B 3/02

(52) U.S. Cl. CPC B60S 3/008; A62B 3/005; B08B 1/12; B08B 3/028

(57) ABSTRACT

A multifunctional cleaning tool for vehicles is provided. Which includes a housing, the housing is provided with a vertical wall body and a horizontal wall body. The vertical wall body abuts against the horizontal wall body and divides an interior of the housing into a first partition area, a second partition area, and a third partition area. The second and third partition areas are located on two sides of the vertical wall body and on the same side of the horizontal wall body, the first partition area is located on the other side of the horizontal wall body. The first partition area is provided with a brush component, a lower of the housing is provided with a first opening. The second partition area is provided with a cleaning component, an upper of the housing is provided with a second opening.

### CROSS-REFERENCE TO RELATED APPLICATIONS

This application claims priority to Chinese Patent Application No. 202520443331.6, filed on Mar. 14, 2025 and Continuation in part of US design application Ser. No. 29/964,075, filed Sep. 20, 2024, which is hereby incorporated by reference in its entirety.

### TECHNICAL FIELD

The present disclosure relates to the field of vehicle mouthed products technologies, and in particular, to a multifunctional cleaning tool for vehicles.

### BACKGROUND

With the continuous increase in the number of vehicles, the importance of on-board emergency equipment is becoming increasingly prominent. At present, there are various types of vehicles mounted emergency equipment on the market, such as window breakers, safety belt cutters, etc. However, these devices usually have single functions and are stored in different locations inside the vehicle, rendering it difficult to quickly obtain and use them in emergency situations and poses certain safety hazards.

On the other hand, as a common vehicle mounted accessory, the vehicle cleaning box is mainly used to store cleaning tools such as cleaning cloths, cleaning brushes, etc. Its functions are relatively simple and can only meet daily cleaning needs, unable to cope with unexpected situations.

In existing technology, there is no vehicle mounted device that combines cleaning and emergency functions. Users carrying both cleaning boxes and emergency equipment in the vehicle not only occupy space, but also easily cause equipment loss or forgetting, which cannot play its due role in emergency situations.

### SUMMARY

To address the shortcomings of existing technology, this solution provides a multifunctional cleaning tool for vehicles that integrates cleaning equipment and safety equipment.

The present disclosure adopts the following technical solution: a multifunctional cleaning tool for vehicles, including a housing, and the housing is provided with a vertical wall body and a horizontal wall body, the vertical wall body abuts against the horizontal wall body and divides an interior of the housing into a first partition area, a second partition area, and a third partition area; the second and third partition areas are located on two sides of the vertical wall body and on the same side of the horizontal wall body, and the first partition area is located on the other side of the horizontal wall body;
the first partition area is provided with a brush component, and a lower of the housing is provided with a first opening that faces downwards and is communicated to the first partition area; the second partition area is provided with a cleaning component, and an upper of the housing is provided with a second opening that faces upwards and is communicated to the second partition area; the third partition area is provided with a window breaker and a safety belt cutter, a window breaking end of the window breaker and a blade of the safety belt cutter are extended to an outer side of the housing;
when it is necessary to perform window breaking or seat belt cutting operations, the housing can be held by a user and subjected to force.

When cleaning the interior of the vehicle, the brush component can be extended downwards from the first opening, or the cleaning component can be extended or pulled out from the first opening to clean a center console of the vehicle. When encountering an emergency moment, this device can break the window with the window breaker and cut a seat belt with the safety belt cutter.

This technical solution integrates brushes, cleaning components, window breakers, and safety belt cutters into the same housing, thereby achieving integrated carrying of cleaning tools and emergency equipment, effectively avoiding equipment loss or forgetting, and ensuring that they can quickly function in emergency situations. Besides that, the housing is divided into three partition areas by vertical and horizontal wall bodies, the second and third partition areas share the vertical wall body, and the first, second, and third partition areas share the horizontal wall body. This design not only optimizes the internal space layout, but also significantly reduces space occupation, rendering the structure more compact and efficient.

Where the window breaker can be any existing window breaker with a striker, and the safety belt cutter can be any existing hidden safety belt cutter.

Where the cleaning component can be a brush or a vehicle cleaning device such as a spray bottle.

In some embodiments of the present disclosure, the safety belt cutter is fixed on a window breaker housing, the housing is provided with a cover housing at the third partition area, and the cover housing is configured to cover the window breaker and the safety belt cutter; an outer wall of the cover housing is provided with parking number plates arranged along its length direction.

By providing the cover housing, a user can avoid accidentally touching the safety belt cutter when using the brush component or cleaning component, thereby improving safety. At the same time, the parking number plates are provided on the outer wall of the cover housing to further enhance the functionality of this device.

In some embodiments of the present disclosure, one end of the cover housing is hinged to the window breaker housing, and the other end of the cover housing is magnetically fixed to the housing; a shape of the cover housing is adapted to a contour of the housing, and when the cover housing is magnetically fixed to the housing, the cover housing and the housing together form a regular shape.

One end of the cover housing is connected to the window breaker housing through a hinge, and the other end thereby is fixed to the housing with magnetic suction, rendering it easy for the user to quickly open the cover housing in emergency situations. Besides that, the shape of the cover housing matches the contour of the housing, and the combination of the two forms a regular shape, which not only enhances the overall aesthetics, but also provides the user with a more comfortable grip experience when using the first brush component.

In some embodiments of the present disclosure, the safety belt cutter is inclined and extends downward, a back of the safety belt cutter is wrapped by the window breaker housing, and a guide slope is provided at the housing close to a wall body of the safety belt cutter, and the guide slope can guide a seat belt to a blade of the safety belt cutter.

The above settings can hide the safety belt cutter to avoid accidental contact by the user, and the guide slope can better guide the seat belt to the blade of the safety belt cutter for use in emergency situations.

In some embodiments of the present disclosure, the vertical wall body is connected to an extension section that extends towards one side of the first partition area, and a cooperation section is provided in the housing that is connected to the extension section and extends laterally; the vertical wall body, extension section, and cooperation section together form the second partition area, and the extension section and cooperation section serve as a shared wall body between the second partition area and the first partition area.

By providing the extension section, the length of the second partition area can be extended, which can accommodate more cleaning components in the second partition area.

In some embodiments of the present disclosure, the brush component includes a brush part and a first sliding part, the housing is provided with a vertically extending guide section in the first partition area, the guide section and the extension section are spaced apart and jointly form the vertically extending guide groove, and the first sliding part is slid in the guide groove; the housing is provided with a vertically extending first sliding groove at the first partition area, and the first sliding part is provided with a first button, the first button is extended outside the housing and slidably fitted with the first sliding groove.

The user can push and pull the first button to cause the first button to slide in the first sliding groove, and the first sliding part drives the brush part to slide to extend or retract from the first opening. At the same time, the extension section not only serves as the wall body of the first partition area, but also as a groove wall of the guide groove, rendering it is compact in structure.

In some embodiments of the present disclosure, the cleaning component is inserted and matched with the second partition area, and the housing is provided with a notch that penetrates inside and outside on a wall body at the second opening;
the cleaning component is a second brush component, and an outer wall of one end of the second brush component located at the second opening is provided with a laterally extending hook protrusion, and the hook protrusion is located at the notch; or
the cleaning component is a spray bottle component.

The housing has a notch that runs through the wall body at the second opening, allowing the user to grab the cleaning component and remove it from the second partition area. Where the hook protrusion is also designed to facilitate the user's grip. Where the spray bottle component is any existing spray bottle that can be inserted into the second partition area, and the spray bottle sprays cleaning solution.

In some embodiments of the present disclosure, the second brush component includes a shell, a first brush and a second brush located at an upper end and a lower end of the shell, respectively; the first brush includes a brush body and a second sliding part that slidably fitted with an interior of the shell; the second sliding part is provided with a laterally extending second button, and an outer wall of the shell has a second sliding groove that causes the second button to extend outwardly and slidably fitted with the second button; the second brush is inserted and matched with a lower end of the shell, and a partition wall body is provided inside the shell to separate the first brush from the second brush; the partition wall body is conical and extends upward to form an avoidance groove for the brush of the second brush; a lower end of the second sliding part is provided with a cone-shaped recess adapted to the partition wall body.

The second brush can be extended or retracted into the shell by pushing and pulling buttons. At the same time, in order to further increase a storage space, the second sliding part and the partition wall body are designed in a conical shape, so that the brushes of the first brush can be avoided, thereby allowing one second brush component to accommodate two brushes, and the first brush is plug-in and replaceable.

In some embodiments of the present disclosure, two ends of the first sliding groove and the second sliding groove are provided with limit holes, and openings of the limit holes are greater than widths of the first sliding groove and the second sliding groove; two limit holes correspond to an extended state or a retracted state of the brush, respectively; the first button and the second button have the same structure and are both provided with limiting parts that cooperate with the limit holes; the first button and the second button are both provided with a spring, and the spring apply a force to the first button and the second button; when the limiting parts are located inside the limit holes, the first button or the second button cannot slide; when the user presses the first button or the second button, the first button or the second button moves inward to release the limiting parts from the limit holes, at this time, the first button or the second button can slide.

By limiting the sliding of the first button and the second button through the limiting parts and the limit holes, the first brush component or the second brush component will not retract when the user uses it.

In some embodiments of the present disclosure, an outer wall of the housing is provided with anti-slip texture, and one side of the housing is provided with Velcro.

The anti-slip texture makes it easy for the user to grip the housing and apply force, and the Velcro can fix the housing on the center console of the vehicle to prevent it from sliding while the vehicle id travelling.

Compared with existing technologies, the present disclosure integrates brushes, cleaning components, window breakers, and safety belt cutters into the same housing, thus having advantages of integrating cleaning tools and emergency equipment, effectively avoiding equipment loss or forgetting, and ensuring that they can quickly function in emergency situations.

### BRIEF DESCRIPTION OF DRAWINGS

FIG. 1 is a schematic structural diagram of the present disclosure.

FIG. 2 is a schematic structural diagram from another perspective of the present disclosure.

FIG. 3 is a schematic structural diagram where a first brush component is extended.

FIG. 4 is a view of a back side of FIG. 3 and an exploded view of FIG. 3 separating from a cover housing.

FIG. 5 is a sectional view of a housing.

FIG. 6 is a sectional view of FIG. 3.

FIG. 7 is a schematic structure diagram of the first brush component.

FIG. 8 is a schematic structure diagram of a window breaker.

FIG. 9 is a schematic structure diagram of a cleaning component.

FIG. 10 is an exploded schematic diagram in FIG. 9.

FIG. 11 is a sectional view of the first brush component.

FIG. 12 is a schematic structural diagram of another embodiment.

Numeral reference: 1—housing; 11—guide slope; 12—magnet; 13—first sliding groove; 14—notch; 15—first opening; 16—second opening; 17—Velcro; 2—cover housing; 21—parking number plate; 3—first brush component; 31—first sliding part; 32—brush part; 33—first button; 4—cleaning component; 41—shell; 411—second sliding groove; 412—partition wall body; 413—hook protrusion; 42—first brush; 421—second sliding part; 422—brush body; 423—second button; 424—cone-shaped recess; 43—second brush; 5—window breaker; 51—window breaker housing; 511—articulated convex shaft; 52—safety belt cutter; 53—striker; 54—compression sleeve; 55—fixed ring; 56—biasing spring; 57—reset spring; 6—limit hole; 61—limiting part; 7—spring; 8—spray bottle component; 91—first partition area; 92—second partition area; 93—third partition area; 100—vertical wall body; 101—extension section; 200—horizontal wall body; 201—cooperation section; 300—guide section; 400—guide groove.

### DESCRIPTION OF EMBODIMENTS

Below is a further description of the present disclosure based on the accompanying drawings and specific embodiments.

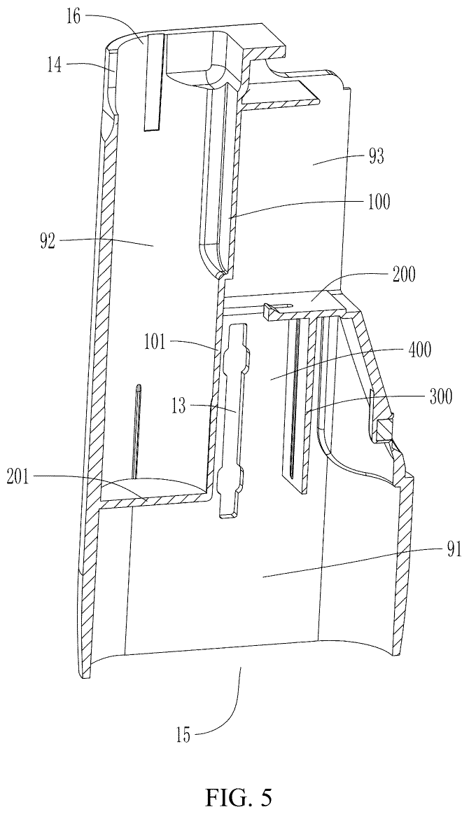

As shown in FIG. 5, an embodiment discloses a multifunctional cleaning tool for vehicles, which includes a housing 1. The housing 1 is provided with a vertical wall body 100 and a horizontal wall body 200. The vertical wall body 100 abuts against the horizontal wall body 200 and divides an interior of the housing 1 into a first partition area 91, a second partition area 92, and a third partition area 93; the second partition area 92 and the third partition area 93 are located on two sides of the vertical wall body 100 and on the same side of the horizontal wall body 200, and the first partition area 91 is located on the other side of the horizontal wall body 200. At a lower end of the vertical wall body 100, there is a downward extending extension section 101, which is integrally formed with the vertical wall body 100. A lower end of the extension section 101 is connected to a horizontally extending cooperation section 201, which is connected to the housing 1. The extension section 101, the cooperation section 201, the vertical wall body, and the housing 1 are enclosed to form the second partition area 92, and a depth of the second partition area 92 is greater than that of the third partition area 93. The extension section 101 and the cooperation section 201 serve as shared wall body for the first partition area 91 and the second partition area 92.

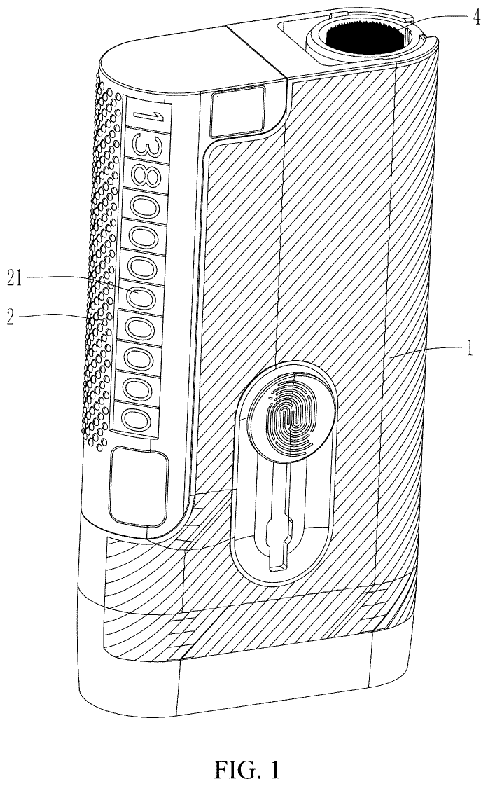

As shown in FIGS. 1 to 6, a lower end of the housing 1 is provided with a first opening 15 that faces downwards and communicates with the first partition area 91, and an upper end of the housing 1 is provided with a second opening 16 that faces upwards and communicates with the second partition area 92. The first partition area 91 is provided with a first brush component 3, the second partition area 92 is provided with a cleaning component 4, and the third partition area 93 is provided with a window breaker 5 and a safety belt cutter 52. The window breaker housing 51 is embedded in the third partition area 93, so that a breaking end of the window breaker is extended to an outer side of the housing 1. The safety belt cutter 52 is fixed on a window breaker housing 51, and a back of the safety belt cutter 52 is wrapped by the window breaker housing 51. There is an anti-slip texture on an outer wall of the housing 1, and a Velcro 17 is further provided on a back of the housing 1.

The third partition area 93 is provided with a cover housing 2, which can cover the window breaker 5 and the safety belt cutter 52. An upper end of the window breaker housing 51 is provided with an articulated convex shaft 511 on two sides, an upper end of the cover housing 2 is hinged to the articulated convex shaft 511. A lower end of cover housing 2 is internally provided with a magnet 12, and a lower end of the housing 1 corresponding to the cover housing 2 also has a magnet 12 to achieve magnetic attraction fixation between the cover housing 2 and the housing 1. There are vertically arranged parking number plates 21 on an outer wall of the cover housing 2. A shape of the cover housing 2 is adapted to a contour of the housing 1. When the cover housing 2 is magnetically fixed to the housing 1, the cover housing 2 and the housing 1 together form a regular shape with an elliptical cross-sectional shape.

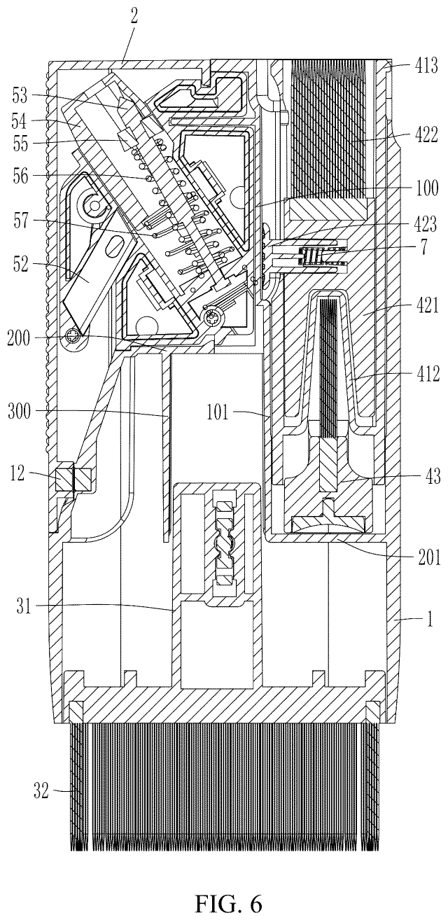

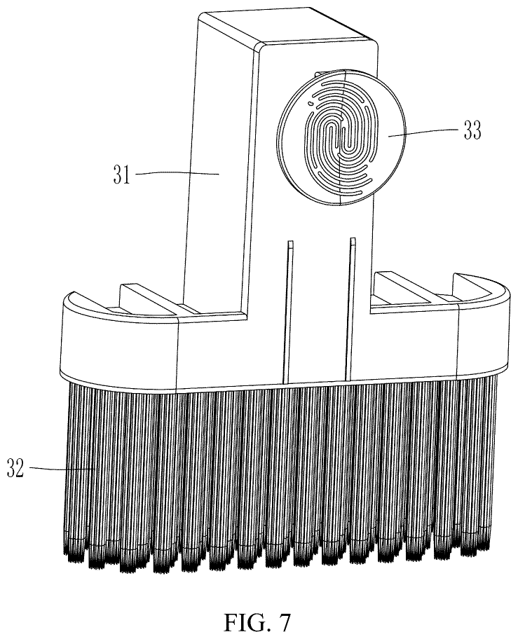

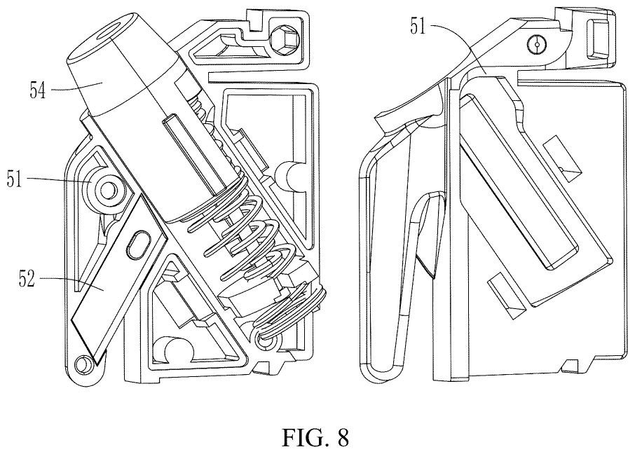

As shown in FIGS. 6 to 8, the window breaker 5 is an existing window breaker, which mainly includes a striker 53, a compression sleeve 54, a fixed ring 55, a biasing spring 56, and a reset spring 57. When the compression sleeve 54 is compressed, the fixed ring 55 fixed on the striker 53 will undergo displacement. Finally, when the fixed ring 55 reaches its limit position, the striker 53 will be driven by the biasing spring 56 to shoot out from a hole of the compression sleeve 54 so as to shatter glass. Then, the reset spring 57 will reset the compression sleeve 54 so that the window breaker can perform secondary window breaking.

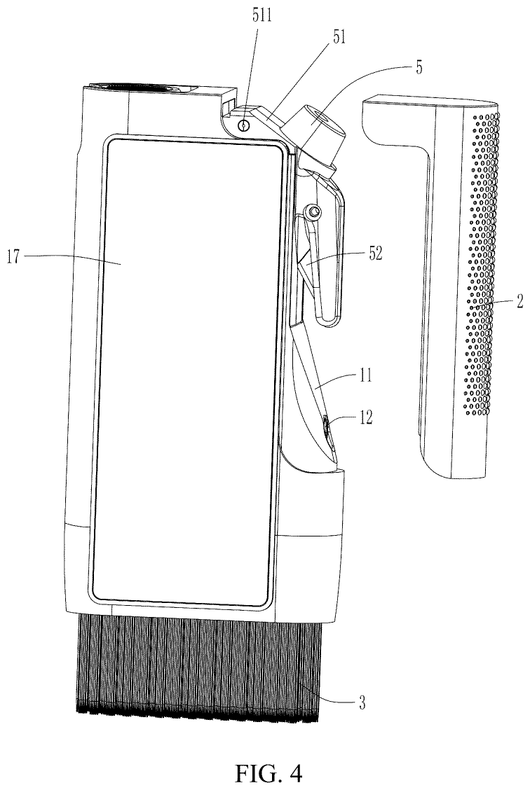

As shown in FIGS. 4, 6, and 8, the safety belt cutter 52 is inclined and extended downwards, and the striker 53 of the window breaker 5 is arranged upwards, so that there is no interference problem between the two. The housing 1 is provided with a guide slope 11 close to a wall of the safety belt cutter 52, and the guide slope 11can guide a seat belt to a blade of the safety belt cutter 52.

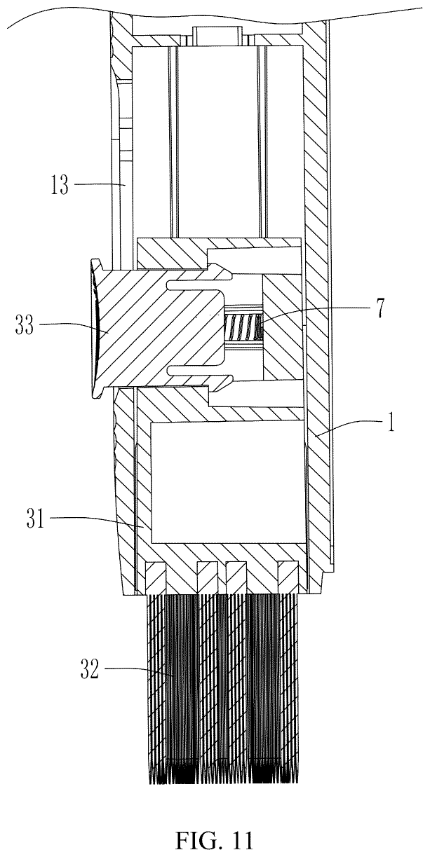

As shown in FIGS. 5 to 7, as well as FIG. 11, the first brush component 3 includes a brush part 32 and a first sliding part 31. The housing 1 is provided with a vertically extending guide section 300 in the first partition area 91. The guide section 300 and the extension section 101 are spaced apart and together form the vertically extending guide groove 400. The first sliding part 31 is slidably fitted in the guide groove 400. A wall bogy of the housing 1 is provided with a vertically extending first sliding groove 13 at the first partition area 91, and the first sliding part 31 is provided with a first button 33. The first button 33 is extended outside the housing 1 and slidably fitted with the first sliding groove 13.

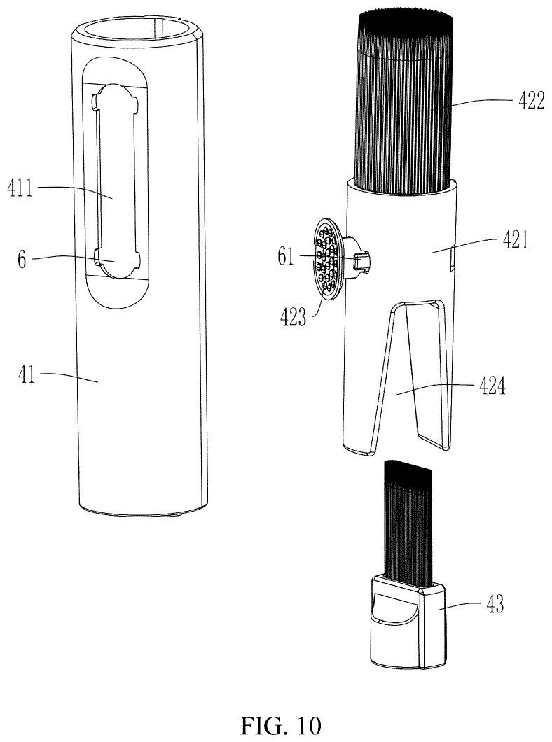

As shown in FIGS. 5, 6, 9, and 10, the housing 1 is provided with a notch 14 that runs through both the inside and outside of the wall at the second opening 16. The cleaning component 4 is a second brush component, and the second brush component includes a shell 41 and first and second brushes 42 and 43 located at upper and lower ends of the shell 41, respectively. An outer wall of one end of the shell 41 located at the second opening 16 is provided with a laterally extending hook protrusion 413, and the hook protrusion 413 is located at the notch 14.

The first brush 42 includes a brush body 422 and a second sliding part 421 that slidably fitted with an interior of the shell 41. The second sliding part 421 is provided with a laterally extending second button 423, and an outer wall of the shell 41 has a second sliding groove 411 that cause the second button 423 to extend and slidably fitted with the second button 423.

The second brush 43 is inserted and matched with a lower end of the shell 41, and a partition wall body 412 is provided inside the shell 41 to separate the first brush 42 from the second brush 43. The partition wall body 412 is conical and extends upward to form an avoidance groove for the brush of the second brush 43. A lower end of the second sliding part 421 is provided with a cone-shaped recess 424 that is compatible with the partition wall body 412.

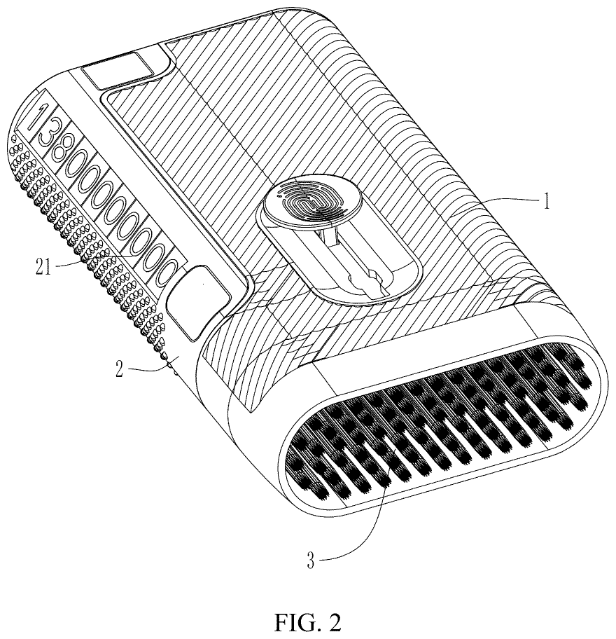

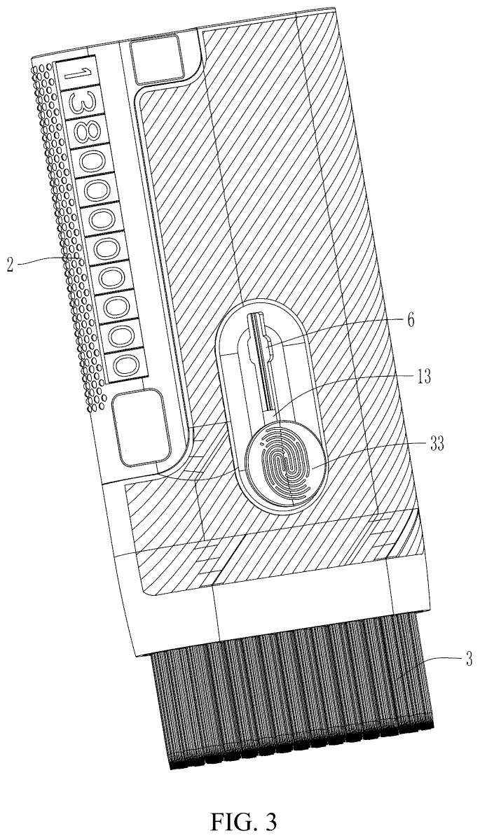

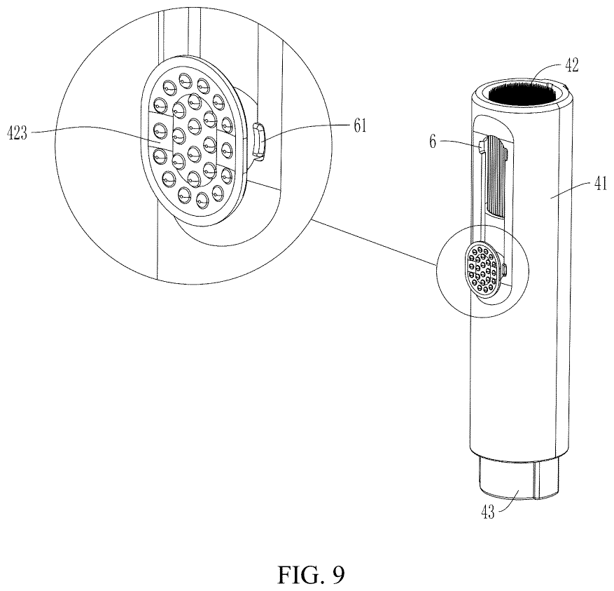

As shown in FIGS. 2 and 3, as well as FIGS. 9 to 11, two ends of the first sliding groove 13 and the second sliding groove 411 are provided with limit holes 6, and openings of the limit holes 6 are larger than widths of the first sliding groove 13 and the second sliding groove 411 (the groove widths of the first sliding groove 13 and the second sliding groove 411). Two limit holes 6 correspond to an extended state or a retracted state of the brush, respectively. The first button 33 and the second button 423 have the same structure, and both are provided with limiting parts 61 that matches the limit holes 6. The limiting parts 61 are convex, and both the first button 33 and the second button 423 are provided with a spring 7, which apply a tendency force to move outward on the first button 33 and the second button 423. When the limiting parts 61 are located in the limit holes 6, the first button 33 or the second button 423 cannot slide. When the user presses the first button 33 or the second button 423, the first button 33 or the second button 423 moves inward to release the limiting parts 61 from the limit holes 6. At this time, the first button 33 or the second button 423 can slide.

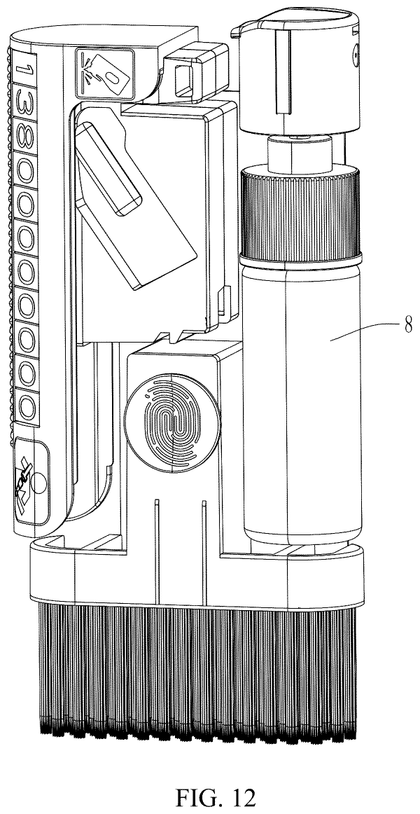

As shown in FIG. 12, in an implementation mode, the cleaning component 4 is a spray bottle component 8, which is any existing device that can spray cleaning liquid or water.

In practical use, when cleaning is required, the user can press the first button 33 and the first button 33 to slide and causes the first brush component 3 to extend outside of the housing 1; the hook protrusion 413 can be pull off, and the second brush component can be pulled out from the second partition area 92 so as to use the second brush 43 and the first brush 42.

In case of emergency, the cover housing 2 can be opened and the housing 1 is holed to align the window breaker 5 with the glass to break the window, or the safety belt cutter 52 is used to cut the seat belt.

What is claimed is:

1. A multifunctional cleaning tool for vehicles, comprising a housing, and the housing is provided with a vertical wall body and a horizontal wall body,
the vertical wall body abuts against the horizontal wall body and divides an interior of the housing into a first partition area, a second partition area, and a third partition area;
the second and third partition areas are located on two sides of the vertical wall body and on the same side of the horizontal wall body, and the first partition area is located on the other side of the horizontal wall body;
the first partition area is provided with a brush component, and a lower of the housing is provided with a first opening that faces downwards and is communicated to the first partition area;
the second partition area is provided with a cleaning component, and an upper of the housing is provided with a second opening that faces upwards and is communicated to the second partition area;
the third partition area is provided with a window breaker and a safety belt cutter, a window breaking end of the window breaker and a blade of the safety belt cutter are extended to an outer side of the housing;
when it is necessary to perform window breaking or seat belt cutting operations, the housing can be held by a user and subjected to force.

2. The multifunctional cleaning tool for vehicles according to claim 1, wherein the safety belt cutter is fixed on a window breaker housing,
the housing is provided with a cover housing at the third partition area, and the cover housing is configured to cover the window breaker and the safety belt cutter;
an outer wall of the cover housing is provided with parking number plates arranged along its length direction.

3. The multifunctional cleaning tool for vehicles according to claim 2, wherein one end of the cover housing is hinged to the window breaker housing, and the other end of the cover housing is magnetically fixed to the housing;
a shape of the cover housing is adapted to a contour of the housing, and when the cover housing is magnetically fixed to the housing, the cover housing and the housing together form a regular shape.

4. The multifunctional cleaning tool for vehicles according to claim 2, wherein the safety belt cutter is inclined and extends downward, a back of the safety belt cutter is wrapped by the window breaker housing, and a guide slope is provided at the housing close to a wall body of the safety belt cutter, and the guide slope can guide a seat belt to a blade of the safety belt cutter.

5. The multifunctional cleaning tool for vehicles according to claim 1, wherein the vertical wall body is connected to an extension section that extends towards one side of the first partition area, and a cooperation section is provided in the housing that is connected to the extension section and extends laterally;
the vertical wall body, extension section, and cooperation section together form the second partition area, and the extension section and cooperation section serve as a shared wall body between the second partition area and the first partition area.

6. The multifunctional cleaning tool for vehicles according to claim 5, wherein the brush component comprises a brush part and a first sliding part,
the housing is provided with a vertically extending guide section in the first partition area, the guide section and the extension section are spaced apart and jointly form the vertically extending guide groove, and the first sliding part is slid in the guide groove;
the housing is provided with a vertically extending first sliding groove at the first partition area, and the first sliding part is provided with a first button, the first button is extended outside the housing and slidably fitted with the first sliding groove.

7. The multifunctional cleaning tool for vehicles according to claim 6, wherein the cleaning component is inserted and matched with the second partition area, and the housing is provided with a notch that penetrates inside and outside on a wall body at the second opening;
the cleaning component is a second brush component, and an outer wall of one end of the second brush component located at the second opening is provided with a laterally extending hook protrusion, and the hook protrusion is located at the notch; or
the cleaning component is a spray bottle component.

8. The multifunctional cleaning tool for vehicles according to claim 7, wherein the second brush component comprises a shell, a first brush and a second brush located at an upper end and a lower end of the shell, respectively;
the first brush comprises a brush body and a second sliding part that slidably fitted with an interior of the shell;
the second sliding part is provided with a laterally extending second button, and an outer wall of the shell has a second sliding groove that causes the second button to extend outwardly and slidably fitted with the second button;
the second brush is inserted and matched with a lower end of the shell, and a partition wall body is provided inside the shell to separate the first brush from the second brush;
the partition wall body is conical and extends upward to form an avoidance groove for the brush of the second brush;
a lower end of the second sliding part is provided with a cone-shaped recess adapted to the partition wall body.

9. The multifunctional cleaning tool for vehicles according to claim 8, wherein two ends of the first sliding groove and the second sliding groove are provided with limit holes, and openings of the limit holes are greater than widths of the first sliding groove and the second sliding groove;
two limit holes correspond to an extended state or a retracted state of the brush, respectively;
the first button and the second button have the same structure and are both provided with limiting parts that cooperate with the limit holes;
the first button and the second button are both provided with a spring, and the spring apply a force to the first button and the second button;
when the limiting parts are located inside the limit holes, the first button or the second button cannot slide;
when the user presses the first button or the second button, the first button or the second button moves inward to release the limiting parts from the limit holes, at this time, the first button or the second button can slide.

10. The multifunctional cleaning tool for vehicles according to claim 1, wherein an outer wall of the housing is provided with anti-slip texture, and one side of the housing is provided with Velcro.
